(19) United States
(12) Patent Application Publication
(10) Pub. No.: US 2024/0276581 A1
(43) Pub. Date: Aug. 15, 2024

(54) MAXIMUM ALLOWED AND ACTIVE LINKS AT AN AP MLD FOR EACH CLIENT

(71) Applicant: QUALCOMM Incorporated, San Diego, CA (US)

(72) Inventors: Abhishek Pramod PATIL, San Diego, CA (US); George CHERIAN, San Diego, CA (US); Andrew MacKinnon DAVIDSON, Monte Sereno, CA (US); Vikram PHOGAT, Fremont, CA (US); Alfred ASTERJADHI, San Diego, CA (US); Srinivas KATAR, Fremont, CA (US)

(21) Appl. No.: 18/427,761

(22) Filed: Jan. 30, 2024

Related U.S. Application Data
(60) Provisional application No. 63/484,477, filed on Feb. 10, 2023.

(51) Int. Cl. H04W 76/20; H04W 76/15

(52) U.S. Cl. CPC H04W 76/20; H04W 76/15

(57) ABSTRACT

This disclosure provides methods, components, devices and systems for performing actions related to maximum allowed and active links at an access point (AP) multilink device (MLD) for each client. An example method performed by an AP MLD includes outputting, for transmission, a first frame indicating at least one of: a first limit on an allowed number of links for association with a multi-link device (MLD) with which the apparatus is affiliated, or a second limit on a number of allowed active links, obtaining, from a client, a request to associate one or more links between the client and the AP MLD, and processing the request subject to at least the first limit.

### CROSS-REFERENCE TO RELATED APPLICATION(S)

This application claims benefit of and priority to U.S. Provisional Application No. 63/484,477, filed Feb. 10, 2023, which is assigned to the assignee hereof and hereby expressly incorporated by reference in its entirety as if fully set forth below and for all applicable purposes.

### TECHNICAL FIELD

This disclosure relates generally to wireless communication, and more specifically, to maximum allowed and active links at an access point (AP) multilink device (MLD) for each client.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

The systems, methods and devices of this disclosure each have several innovative aspects, no single one of which is solely responsible for the desirable attributes disclosed herein.

One aspect provides an apparatus for wireless communication. The method includes a memory comprising processor-executable instructions; one or more processors configured to execute the processor-executable instructions and cause the apparatus to: outputting, for transmission, a first frame indicating at least one of: a first limit on an allowed number of links for association with a multi-link device (MLD) with which the apparatus is affiliated, or a second limit on a number of allowed active links; obtaining, from a client, a request to associate one or more links between the client and the AP MLD; and processing the request subject to at least one of the first limit or the second limit.

Another aspect provides an apparatus for wireless communication. The method includes a memory comprising processor-executable instructions; one or more processors configured to execute the processor-executable instructions and cause the apparatus to: obtaining a first frame indicating at least one of: a first limit on an allowed number of links for association with a multi-link device (MLD) affiliated with an access point (AP), or a second limit on a number of allowed active links; and outputting a request to associate one or more links between the apparatus and the MLD, subject to at least one of the first limit or the second limit.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a pictorial diagram of another example wireless communication network.

FIG. 3 shows a block diagram of an example multi-link device (MLD) deployment.

FIG. 4 shows a call flow diagram, in accordance with certain aspects of the present disclosure.

FIG. 5 shows a method for wireless communications.

FIG. 6 shows a method for wireless communications.

FIG. 7 shows aspects of an example communications device.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

A multi-link device (MLD) generally consists of one or more affiliated STAs. An AP MLD generally refers to an MLD whose affiliated STA(s) are AP(s). A non-AP MLD generally refers to an MLD whose affiliated STA(s) are non-AP STA(s). Each STA of an MLD operates on a link. A link is a tuple consisting of {BSSID of the AP operating on the link, Channel, Operating class}. Frame transmission and reception is done by an affiliated STA.

Multi-link operation (MLO) generally refers to a feature in advanced wireless systems (e.g., 802.11be Extremely High Throughput (EHT)) that enables the utilization of multiple links using individual frequency channels to transmit and receive between devices. MLO may enable concurrent utilization of multiple radio links of different frequency channels/bands by an AP, a client, or both.

MLO enables a pair of devices to use multiple wireless links in different bands simultaneously for transmission and reception. MLO allows simultaneous use of multiple bands and also enhances the throughput of a single data session, while current multiband APs may allow client devices to connect using only one band at a time. Ideally, the maximum achievable throughput of MLO is the sum of the achievable throughput for each link.

In some systems, a direct link between client devices, referred to as a peer-to-peer (P2P) or direct link, may be established between stations (STAs), while one or more of the stations may also remain associated with an AP. These P2P mechanisms may help reduce the amount of traffic that is transferred in the network and prevent congestion at the AP. A P2P link may be set up automatically between the devices, without intervention from the AP or the user, and the connection with the AP may be maintained.

As noted above, certain multilink devices (MLDs) are capable of supporting (e.g., associating with and operating on) several links (e.g., 5 links). However, in some cases, an AP MLD may not be capable, or may not have resources to support non-AP MLDs that operate on a particular number of links. For example, some AP-MLDs may only be capable of supporting 2 links. Thus, it may be useful for an AP MLD (e.g., an AP MLD that supports several links) to be able to limit the number of links that are allowed to associate with the AP MLD.

In some cases, an access point (AP) MLD has a choice of accepting a subset of links (e.g., association links) that are requested (e.g., and rejecting a subset of the requested links). For example, in some cases, a 1:1 traffic identifier (TID)-to-link (T2LM) mapping negotiation may be used to address the problem. In a T2LM mapping negotiation, both parties (AP MLD and non-AP MLD) may request a mapping/link, and both parties may reject requested mappings/links. For example, in some cases, a non-AP MLD may reject an AP MLD's request for a link in a T2LM mapping negotiation. In some cases, a non-AP MLD may request any number of links, and an AP MLD may be allowed to reject any of the requested links.

It may be advantageous for a non-AP MLD to know an upper bound of links that an AP-MLD may allow (e.g., before sending a request for one or more mappings/links). Aspects of the present disclosure provide techniques that may enable an AP-MLD to advertise limits on a number of associated and/or active links.

For example, in some cases, an AP MLD may inform one or more non-AP MLDs of a first limit on maximum allowed links for association and/or a second limit for maximum allowed active links. Such information may allow a non-AP MLD to apply power saving procedures (e.g., per link power-save) to limit the number of links that it requests and/or the number of links that it is active on, allowing the non-AP MLD to meet the AP MLD's requirement while decreasing power consumption.

### Example Wireless Communication Network

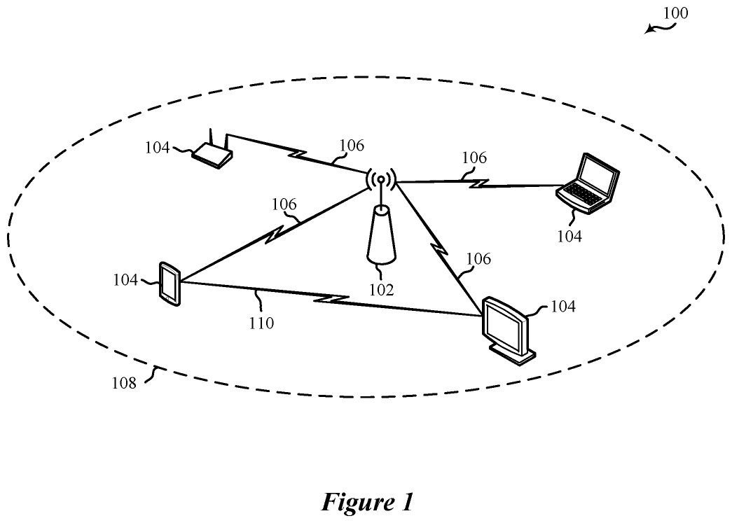

FIG. 1 shows a block diagram of an example wireless communication network 100. According to some aspects, the wireless communication network 100 can be an example of a WLAN such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8). The WLAN 100 may include numerous wireless communication devices such as a wireless AP 102 and multiple wireless STAs 104. While only one AP 102 is shown in FIG. 1, the WLAN network 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE, 5G NR, etc.) can be further improved by a small cell which is supported by an AP serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (for example, TVs (including smart TVs), computer monitors, navigation systems, among others), music or other audio or stereo devices, remote control devices (“remotes”), printers, kitchen appliances (including smart refrigerators) or other household appliances, key fobs (for example, for passive keyless entry and start (PKES) systems), Internet of Things (IoT) devices, and vehicles, among other examples. The various STAs 104 in the network are able to communicate with one another via the AP 102.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some examples of the APs 102 and STAs 104 described herein also may communicate in other frequency bands, such as the 5.9 GHz and the 6 GHz bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4 GHz, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

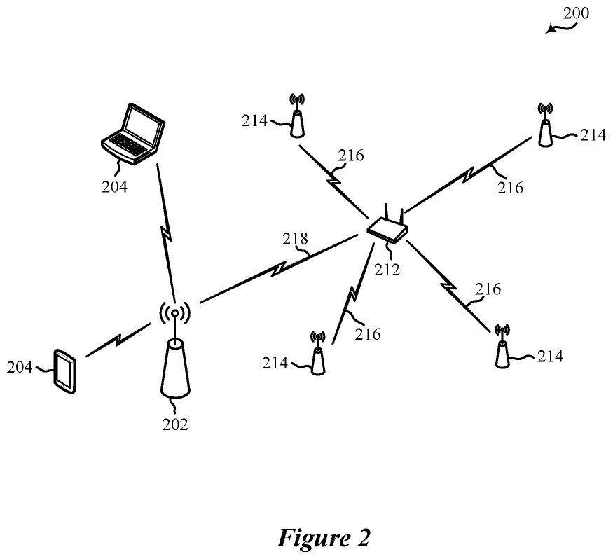

FIG. 2 shows a pictorial diagram of another example wireless communication network 200. According to some aspects, the wireless communication network 200 can be an example of a mesh network, an IoT network or a sensor network in accordance with one or more of the IEEE 802.11 family of wireless communication protocol standards (including the 802.11ah amendment). The wireless network 200 may include multiple wireless communication devices 214. The wireless communication devices 214 may represent various devices such as display devices (for example, TVs, computer monitors, navigation systems, among others), music or other audio or stereo devices, remote control devices (“remotes”), printers, kitchen or other household appliances, among other examples.

In some examples, the wireless communication devices 214 sense, measure, collect or otherwise obtain and process data and then transmit such raw or processed data to an intermediate device 212 for subsequent processing or distribution. Additionally or alternatively, the intermediate device 212 may transmit control information, digital content (for example, audio or video data), configuration information or other instructions to the wireless communication devices 214. The intermediate device 212 and the wireless communication devices 214 can communicate with one another via wireless communication links 216. In some examples, the wireless communication links 216 include Bluetooth links or other PAN or short-range communication links.

In some examples, the intermediate device 212 also may be configured for wireless communication with other networks such as with a Wi-Fi WLAN or a wireless (for example, cellular) wide area network (WWAN), which may, in turn, provide access to external networks including the Internet. For example, the intermediate device 212 may associate and communicate, over a Wi-Fi link 218, with an AP 202 of a WLAN network, which also may serve various STAs 204. In some examples, the intermediate device 212 is an example of a network gateway, for example, an IoT gateway. In such a manner, the intermediate device 212 may serve as an edge network bridge providing a Wi-Fi core backhaul for the IoT network including the wireless communication devices 214. In some examples, the intermediate device 212 can analyze, preprocess and aggregate data received from the wireless communication devices 214 locally at the edge before transmitting it to other devices or external networks via the Wi-Fi link 218. The intermediate device 212 also can provide additional security for the IoT network and the data it transports.

Aspects of transmissions may vary according to a distance between a transmitter (for example, an AP 102 or a STA 104) and a receiver (for example, another AP 102 or STA 104). Wireless communication devices may generally benefit from having information regarding the location or proximities of the various STAs 104 within the coverage area. In some examples, relevant distances may be determined (for example, calculated or computed) using RTT-based ranging procedures. Additionally, in some examples, APs 102 and STAs 104 may perform ranging operations. Each ranging operation may involve an exchange of fine timing measurement (FTM) frames (such as those defined in the 802.11az amendment to the IEEE family of wireless communication protocol standards) to obtain measurements of RTT transmissions between the wireless communication devices.

### Overview of Multi-Link Devices

As initially described above, a multi-link device (MLD) generally refers to a single device or equipment that includes two or more station (STA) instances or entities, implemented in a physical (PHY)/medium access control (MAC) layer and configured to communicate on separate wireless links. In some examples, each MLD may include a single higher layer entity, such as a MAC Service Access Point (SAP) that may assign MAC protocol data units (MPDUs) for transmission by the separate STA instances.

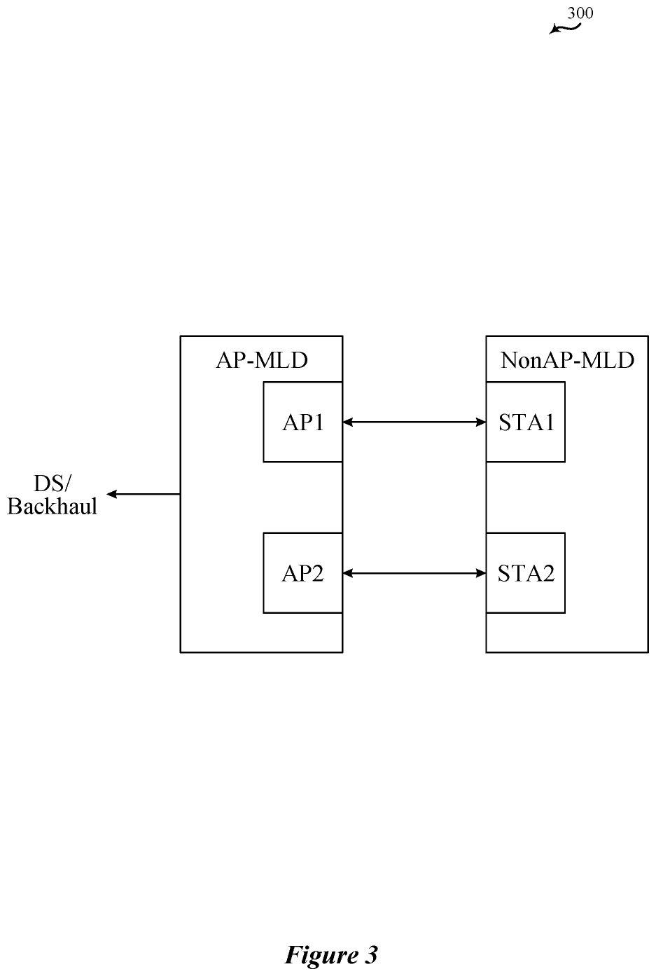

FIG. 3 shows a block diagram 300 of an example MLD deployment. As shown in FIG. 3, an access point (AP) MLD may communicate with a non-AP MLD. Each of the AP MLD and non-AP MLD may include at least two STA entities (hereinafter also referred to simply as “STAs”) that may communicate with associated STAs of another MLD. In an AP MLD, the STAs may be AP STAs (STAs serving as APs or simply “APs”). In a non-AP MLD, the STAs may be non-AP STAs (STAs not serving as APs). As also described above, MLDs may utilize multi-link aggregation (MLA) (which includes packet level aggregation), whereby MPDUs from a same traffic ID (TID) may be sent via two or more wireless links.

Various modes of communication may be employed in MLD implementations. For example, a MLD may communicate in an Asynchronous (Async) mode or a Synchronous (Sync) mode.

In the Async mode, a STA/AP may count down (e.g., via a random backoff (RBO)) on both wireless links. A physical layer convergence protocol (PLCP) protocol data units (PPDU) start/end may happen independently on each of the wireless links. As a result, Async mode may potentially provide latency and aggregation gains. In certain cases, relatively complex (and costly) filters may be needed (e.g., in the case of 5 GHz+6 GHz aggregation).

In the Sync mode, a STA/AP may also count down on both wireless links (e.g., assuming Link 1 and Link 2). If a first link (e.g., Link 1) wins the medium, both links may transmit PPDUs at the same time. Accordingly, this mode may benefit from some restrictions to minimize in-device interference.

The Sync mode may work in 5 GHz+6 GHz aggregation and may require relatively low-filter performance, while still providing latency and aggregation gains. However, due to that STA's tiled architecture, this latency and aggregation gains may be difficult to achieve.

Although not shown, a third mode of communication may include a Basic (e.g., multi-primary with single link transmission) mode. In the Basic mode, a STA/AP may also count down on both wireless links. However, transmission may only occur on the wireless link that wins the medium. The other wireless link may be blocked by in-device interference greater than −62 decibels per milliwatt (dBm). No aggregation gains may be realized in this mode.

One potential issue with MLO deployments is blocking, which may need to be addressed for better band management. Other potential issues for APs and clients that may limit MLO deployments is that APs need to manage individual client radio usage and offer service on multiple radios, while limiting the number of links that a single client can switch between. An AP may also want to limit the number of radios that a client can be active (e.g., transmit/receive) on at a time to manage load.

Customers (e.g., clients) may view MLO as a tool to adapt to dynamic traffic load, link quality and collocated operations. It may be desirable to have autonomy to manage performance. Most scenarios may only need at most two active links, but may benefit from the ability to easily switch between more bands/channels (e.g., to adapt to changing conditions/mobility).

Aspects of the present disclosure provide mechanisms that may be added to MLO negotiation to enable the desired behavior noted above. In some cases, an AP may advertise a maximum number of links on which a client can associate and/or a maximum number of links on which a client can be active (e.g., use for transmission/reception). Based on this information, a client can use Power Save (PS) to change which links are active between the associated set, subject to the advertised maximums.

Aspects of the present disclosure may help improve AP band management, allowing an AP manage its resources to meet the needs of all clients while delivering the required service to each. This may be achieved by allowing an AP MLD that operates several links to limit the number of links a non-AP MLD can associate on and to advertise such a limit. This may be beneficial so a non-AP MLD may be aware, in advance, of the upper bound, so that it can request links that are most suitable to it within the limits set by the AP. Within the accepted links, an AP MLD may want to limit the number of links a non-AP MLD may be active on. Effectively managing the number of concurrently active links in this manner may help decrease the complexity of deploying MLO

### Aspects related to Indicating Limits on Allowed and Active Links at an AP MLD for each Client

As noted above, MLDs may be capable of supporting (e.g., associating with and operating on) various numbers of links. Thus, it may be advantageous for a non-AP MLD to know an upper bound of links that an AP-MLD may allow. Aspects of the present disclosure provide techniques that may enable an AP-MLD to inform one or more non-AP MLDs of a first limit on maximum allowed links for association and a second limit for maximum allowed active links. Such information may allow a non-AP MLD to apply power saving procedures (e.g., per link power-save) to limit the number of links that it requests and/or the number of links that it is active on, allowing the non-AP MLD to meet the AP MLD's requirement.

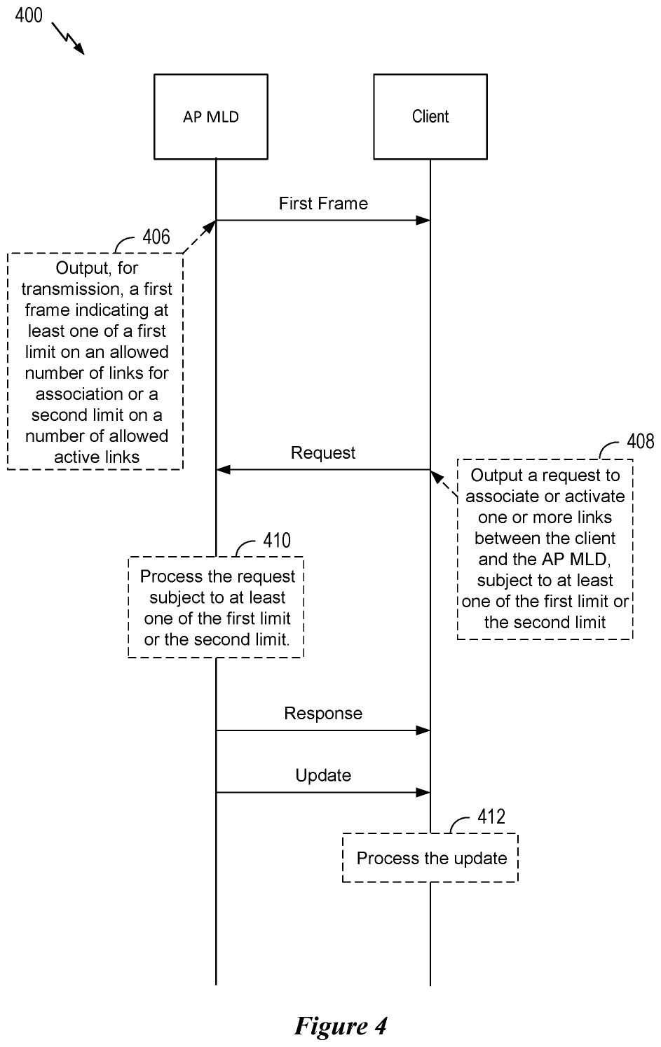

Techniques proposed herein for implementing limits on allowed and/or active links may be understood with reference to the call flow diagram 400 of FIG. 4.

As indicated at 406, an AP MLD (an AP affiliated with an MLD) may output, for transmission to a client (e.g., a non-AP MLD), a first frame indicating at least one of a first limit on an allowed number of links for association or a second limit on a number of allowed active links.

As indicated at 408, the client may output a request to associate or activate one or more links between the client and the AP MLD, subject to at least one of the first limit or the second limit. As indicated at 410, the AP MLD may process the request subject to at least one of the first limit or the second limit.

In some cases, the AP MLD may send a response to the request. As will be described in greater detail below, the response may indicate acceptance of the request (e.g., acceptance/establishing one or more links) or, in some cases, rejection of the request (e.g., rejecting one or more links). In case of rejection, the response may indicate an error code that one or both of the first or second limits were exceeded.

As will be described in greater detail below, in some cases, the AP-MLD may indicate an update to one or both of the first or second limits. In such cases, the update may be sent association with at least one of the critical update flag (CUF) in the Capability Information field being set to 1, the BSS Parameter Change Count (BPCC) field corresponding to at least one affiliated AP getting incremented or the All Updates Flag corresponding to at least one affiliated AP being set to 1.

In some cases, a new field may be defined in a Common Info field of a Basic Multi-Link information element (IE) for one or both of the first and second limits (e.g., a Max Allowed Assoc Links field/subfield and a Max Active Links field/subfield). For example, the Max Active Links field may indicate a recommended quantity of maximum simultaneous links. Such a field may span 4 bits, and may define a recommended maximum number of enabled links that a non-AP MLD can operate on for simultaneous frame exchanges. In some aspects, when an AP MLD indicates/advertises a value L (e.g., where L is greater than 1) in the Max Active Links (sub)field of the Basic Multi-Link element that is carried in Beacon or broadcast Probe Response frames, an associated non-AP MLD should not exchange frames simultaneously on more than L links. In some aspects, a value of 0 may indicate that the AP MLD does not advertise any such limit, and a value of 1 may be reserved.

In some cases, if a Limit Association And Active Links subfield is present in the Basic Multi-Link element transmitted by an AP affiliated with an AP MLD and the AP has indicated a nonzero value in either the Max Allowed Association subfield or the Max Active Links (sub)field, then behavior may depend on a value of the Support Limiting Association And Active Links subfield in the Basic Multi-Link element transmitted by the non-AP MLD. For example, if this subfield is set to:

0, then the AP MLD shall not accept, during multi-link (re)setup, total links greater than the value indicated in the Max Active Links subfield in a Basic Multi-Link element transmitted by the AP affiliated with the AP MLD; or
1 and the number of links requested by the non-AP MLD, during multi-link (re)setup, exceeds the value indicated in the Max Allowed Association subfield in Basic Multi-Link element transmitted by the AP affiliated with the AP MLD, then the AP MLD shall not accept links greater than the value indicated in the Max Allowed Association subfield.

In some aspects, the frame may include one or more fields (e.g., a Presence Bitmap subfield) to indicate a presence of at least one of the Max Allowed Assoc Links field or the Max Active Links field. At least one of the first or second limits may be advertised in a beacon frame, a probe response frame, an association response frame, or a re-association response frame.

According to certain aspects, a non-AP MLD may obtain/receive the advertised Max Allowed Assoc Links field and a Max Active Links field, indicating respectively, the maximum number of links to which a client is allowed to associate, and a maximum number of links that the client is allowed to be active on at any given time. In certain aspects, the non-AP MLD may provide an indication that the client supports at least one of the Allowed Assoc Links field or the Max Active Links field.

The non-AP may consider the advertised limits when negotiating links with the AP-MLD. For example, in some aspects, a non-AP MLD may request association for X links, where X<=Max Allowed Assoc Links. In such aspects, the non-AP MLD may select the X links from a set of links advertised by the AP.

According to certain aspects, a non-AP MLD may be active (e.g., for uplink and downlink) on Y links, where Y<=min(Max Active Links, X). In such aspects, the non-AP MLD may select the Y links that it is active on (e.g., for uplink and downlink).

According to certain aspects, an indication may be provided by an AP MLD, to a non-AP MLD, for rejecting a certain link (e.g., rejecting a certain link in an association request) if the non-AP MLD's request exceeds Max Allowed Assoc Links. For example, in certain aspects, a status code (e.g., Exceeds Max Allowed Assoc Links) may be defined for rejecting a certain link if the non-AP MLD's request exceeds Max Allowed Assoc Links. For example, in some cases, a multi-link association (e.g., resulting from a multi-link association request) may be successful, but one or more links requested in the association request may be rejected (e.g., using the defined status code). In some aspects, the multi-link association may be rejected (e.g., with the status code indicating Exceeds Max Allowed Assoc Links) if the non-AP MLD's multi-link association request includes total number of links that exceeds Max Allowed Assoc Links.

According to certain aspects, an AP-MLD may update/change a value advertised in at least one of the Max Allowed Assoc Links field or the Max Active Links field. In such aspects, the update may be treated as a critical update (e.g., a priority flag/critical update flag (CUF) may be set to 1) so that a non-AP MLD may become aware and conform to the new advertised limits/maximum values. According to certain aspects, an add/remove procedure may be used to add or remove one or more links to satisfy a new value of a Max Allowed Assoc Links field (e.g., after association).

In some cases, an update may be indicated in a second frame with a flag indicating that there is an update to parameters of the apparatus or MLD with which the apparatus is affiliated with. In some case, the second frame may indicate a counter associated with the parameters of the apparatus or the MLD with which the apparatus is affiliated with. This counter may correspond to an incrementing BSS Parameter Change Count (BPCC), carried in the Basic ML IE for the reporting AP and in the Reduced Neighbor Report (RNR) element for reported AP. The second frame may include a flag indicating that information related to the update is included in the second frame itself. This flag may be referred to as an All-Updates-Included flag that indicates that the update that causes the BPCC to increment is carried within the same frame-in other words the receiving STA does not need to send a probe request or listen to the beacon frame to retrieve the update.

According to certain aspects, a non-AP MLD may indicate a number of active links to the AP-MLD. In certain aspects, the non-AP MLD may use a power management (PM) subfield in the frame header to indicate an active state (e.g., or an inactive state). In some cases, for example, PM=0 indicates an active state and PM=1 indicates a power save (e.g., inactive or doze) state.

In some scenarios, an AP MLD may advertise/broadcast a Max Active Links field indicating a maximum number of links, L, that the client is allowed to be active on at any given time, and a non-AP MLD may set/indicate a number of active links that is greater than L. According to certain aspects, the AP MLD may consider the L links that were most recently signaled as active (e.g., PM=0) and consider all other links inactive.

Aspects of the present disclosure may help address the following scenario, for example, where association may be available on various links (e.g., 2.4/5/6 GHz), with a maximum of 2 active links. In one example scenario, the 5 and 6 GHz links may be currently active (PM=0), but unreachable. From the non-AP perspective, no link is active though, from the AP MLD perspective, 2 links active (5 GHz and 6 GHz). The non-AP may then activate the 2.4 GHz link (e.g., setting PM=0), such that, from the AP MLD perspective 3 links are active (2.4/5/6 GHz links). In other words, the non-AP MLD and AP MLD may be out of sync on the number of active links.

There are various potential solutions to this problem. For example, a Non-AP could initiate TID to link mapping (T2LM) on 2.4 GHz to disable 5 and 6 GHz links. In this case, the T2LM Request frame may indicates PM=0. The AP MLD may be expected to understand that non-AP MLD is turning off at least one of the 2 (currently) active links and activating 1 link, while the expected view at the AP MLD may be that 1 link is active (2.4 GHz). The outcome of this 1:1 T2LM negotiation may not be guaranteed. However in such a scenario, T2LM negotiation may need to be treated as mandatory.

Another potential solution involves cross-link power-save, in which the Non-AP signals PM=1 for 5 or 6 GHz links, via 2.4 GHz, while indicating PM=0 for 2.4 GHz.

Another potential solution involves new signaling, such as an explicit management frame exchange to indicate which links are active/operational. For example, a Non-AP MLD can send a management frame on 2.4 GHz to turn off 5 & 6 GHz while turning on 2.4 GHz.

In some cases, a multilink reconfiguration (e.g., ML Reconfig) may be performed in order to remove the links that are out of reach and add them back when they are in range. In such cases, the Non-AP STAs on links 5/6 GHz may keep monitoring the beacons to determine reach.

In some cases, flexible target wakeup time (TWT) information may be used. A TWT information frame may control the PM state of the link where it is transmitted even if the transmitting and receiving STAs do not have TWT setup between them. In some cases (for example for TWT Information frame exchange between EHT STAs), cross-link TWT Information may be added to allow a change to a PM state of other links (a less known way to do cross-link PS).

Another potential solution involves an AP advertising time within which the non-AP cannot change its ‘operational’ link to go beyond the maximum allowed. One potential issue is that a Non-AP may be stuck on the current link setup until the expiration of the ‘window.’ In some cases, the Non-AP may be required to be in awake state after sending PS-Poll. A non-AP could send QoS Null (PM=0) followed by another QoS Null, while an AP may not be able to serve due to a busy channel.

Another potential solution involves a Non-AP maintaining its ‘operational’ set of links for a well-defined period of time. In such cases a TBTT of a link with lowest Link ID (e.g., allowed to change the link set at each TBTT epoch). A Non-AP can send PS-Poll or have PM=0 within the same set until next TBTT. In such cases, there may be no need to advertise change, as an AP may determine a new set based on link(s) on which frames are received.

### Example Operations

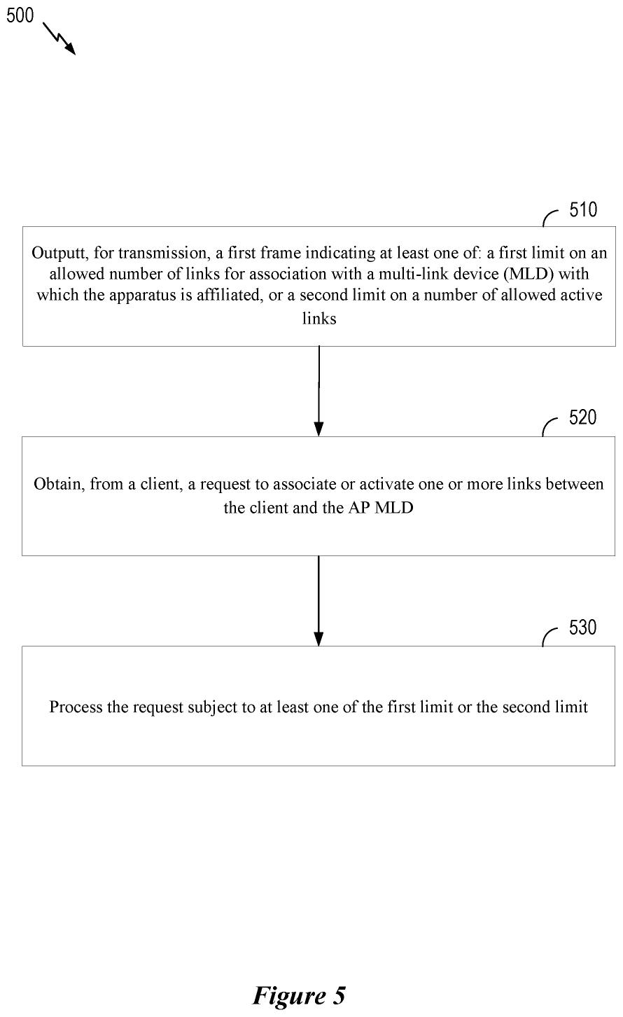

FIG. 5 shows an example of a method 500 of wireless communication at a AP, such as an AP 102 of FIGS. 1 and 2.

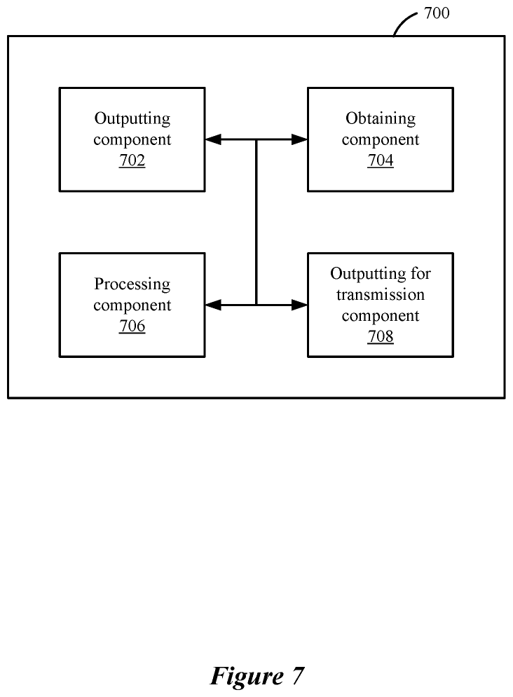

Method 500 begins at step 510 with outputting, for transmission, a first frame indicating at least one of: a first limit on an allowed number of links for association with a multi-link device (MLD) with which the apparatus is affiliated, or a second limit on a number of allowed active links. In some cases, the operations of this step refer to, or may be performed by, circuitry for outputting and/or code for outputting as described with reference to FIG. 7.

Method 500 then proceeds to step 520 with obtaining, from a client, a request to associate or activate one or more links between the client and the AP MLD. In some cases, the operations of this step refer to, or may be performed by, circuitry for obtaining and/or code for obtaining as described with reference to FIG. 7.

Method 500 then proceeds to step 530 with processing the request subject to at least one of the first limit or the second limit. In some cases, the operations of this step refer to, or may be performed by, circuitry for processing and/or code for processing as described with reference to FIG. 7.

In some aspects, the client is affiliated with a non-AP MLD.

In some aspects, the first frame comprises a beacon frame, a probe response frame, an association response frame, or a re-association response frame.

In some aspects, at least one of the first limit or the second limit is output for transmission in a common information field of a basic multi-link information element (IE).

In some aspects, the first frame includes at least one field indicate a presence of at least one of the first limit and the second limit.

In some aspects, the method 500 further includes obtaining an indication that the client supports the first and second limits. In some cases, the operations of this step refer to, or may be performed by, circuitry for obtaining and/or code for obtaining as described with reference to FIG. 7.

In some aspects, the method 500 further includes processing the request subject to the first limit and the second limit only after obtaining the indication. In some cases, the operations of this step refer to, or may be performed by, circuitry for processing and/or code for processing as described with reference to FIG. 7.

In some aspects, the method 500 further includes outputting the frame indicating the first limit and the second limit only after obtaining the indication. In some cases, the operations of this step refer to, or may be performed by, circuitry for outputting and/or code for outputting as described with reference to FIG. 7.

In some aspects, processing the request comprises outputting, for transmission to the client, an indication that at least one of the one or more links is rejected if a number of links indicated in the request exceeds the first limit. The rejection could be an entire association or only for the extra links (beyond a maximum) that were requested as part of the association.

In some aspects, the indication comprises a status code indicating that at least one of the one or more links is rejected because the number of links indicated in the request exceeds the first limit.

In some aspects, the method 500 further includes outputting, for transmission, a second frame indicating an update to at least one of the first limit or the second limit. In some cases, the operations of this step refer to, or may be performed by, circuitry for outputting and/or code for outputting as described with reference to FIG. 7.

In some aspects, the second frame includes at least one of: a flag indicating that there is an update to one or more operational parameters of at least one of the apparatus or the MLD with which the apparatus is affiliated, an update to a counter associated with the one or more operational parameters of at least one of the apparatus or the MLD with which the apparatus is affiliated, or a flag indicating that information related to the update is included in the second frame.

In some aspects, the method 500 further includes performing a procedure to add or remove at least one link based on the update. In some cases, the operations of this step refer to, or may be performed by, circuitry for performing and/or code for performing as described with reference to FIG. 7.

In some aspects, the method 500 further includes obtaining, from the client, an indication that more than the second limit of links are in an active state. In some cases, the operations of this step refer to, or may be performed by, circuitry for obtaining and/or code for obtaining as described with reference to FIG. 7.

In some aspects, the method 500 further includes designating most recently activated links, up to the second limit, as active after receiving the indication. In some cases, the operations of this step refer to, or may be performed by, circuitry for designating and/or code for designating as described with reference to FIG. 7.

In one aspect, method 500, or any aspect related to it, may be performed by an apparatus, such as communications device 700 of FIG. 7, which includes various components operable, configured, or adapted to perform the method 500. Communications device 700 is described below in further detail.

Note that FIG. 5 is just one example of a method, and other methods including fewer, additional, or alternative steps are possible consistent with this disclosure.

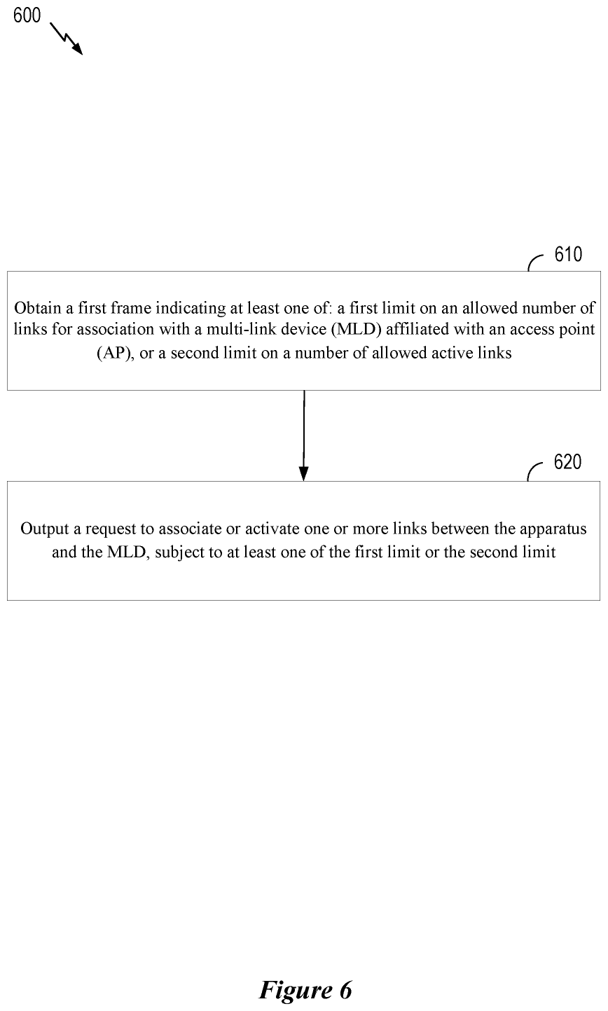

FIG. 6 shows an example of a method 600 of wireless communication at a AP, such as a STA 120 of FIGS. 1 and 2.

Method 600 begins at step 610 with obtaining a first frame indicating at least one of: a first limit on an allowed number of links for association with a multi-link device (MLD) affiliated with an access point (AP), or a second limit on a number of allowed active links. In some cases, the operations of this step refer to, or may be performed by, circuitry for obtaining and/or code for obtaining as described with reference to FIG. 7.

Method 600 then proceeds to step 620 with outputting a request to associate or activate one or more links between the apparatus and the MLD, subject to at least one of the first limit or the second limit. In some cases, the operations of this step refer to, or may be performed by, circuitry for outputting and/or code for outputting as described with reference to FIG. 7.

In some aspects, the apparatus is affiliated with a non-AP MLD.

In some aspects, the first frame comprises a beacon frame, a probe response frame, an association response frame, or a re-association response frame.

In some aspects, at least one of the first limit or the second limit is obtained in a common information field of a basic multi-link information element (IE).

In some aspects, the first frame includes at least one field indicate a presence of at least one of the first limit and the second limit.

In some aspects, the method 600 further includes outputting, for transmission, an indication that the apparatus supports the first and second limits. In some cases, the operations of this step refer to, or may be performed by, circuitry for outputting and/or code for outputting as described with reference to FIG. 7.

In some aspects, the method 600 further includes obtaining an indication that at least one of the one or more links is rejected, wherein the indication comprises a status code indicating that at least one of the one or more links is rejected because the number of links indicated in the request exceeds the first limit. In some cases, the operations of this step refer to, or may be performed by, circuitry for obtaining and/or code for obtaining as described with reference to FIG. 7.

In some aspects, the method 600 further includes obtaining a second frame indicating an update to at least one of the first limit or the second limit. In some cases, the operations of this step refer to, or may be performed by, circuitry for obtaining and/or code for obtaining as described with reference to FIG. 7.

In some aspects, the second frame includes at least one of: a flag indicating that there is an update to one or more operational parameters of at least one of the apparatus or the MLD, an update to a counter associated with the one or more operational parameters of at least one of the apparatus or the MLD, or a flag indicating that information related to the update is included in the second frame.

In some aspects, the method 600 further includes performing a procedure to add or remove at least one link based on the update. In some cases, the operations of this step refer to, or may be performed by, circuitry for performing and/or code for performing as described with reference to FIG. 7.

In some aspects, performing a procedure to add or remove at least one link based on the update comprises updating a power management state of at least one link, based on the update.

In one aspect, method 600, or any aspect related to it, may be performed by an apparatus, such as communications device 700 of FIG. 7, which includes various components operable, configured, or adapted to perform the method 600. Communications device 700 is described below in further detail.

Note that FIG. 6 is just one example of a method, and other methods including fewer, additional, or alternative steps are possible consistent with this disclosure.

### Example Communications Device(s)

FIG. 7 depicts aspects of an example communications device 700. In some aspects, communications device 700 is a station, such as a STA 120 described above with respect to FIGS. 1 and 2. In some aspects, communications device 700 is an access point, such as an AP 102 described above with respect to FIGS. 1 and 2. Outputting component 702 may comprise circuitry for outputting and/or code for outputting. Obtaining component 704 may comprise circuitry for obtaining and/or code for obtaining. Processing component 706 may comprise circuitry for processing and/or code for processing. Outputting for transmission component 708 may comprise may comprise circuitry for outputting for transmission and/or code for outputting for transmission.

Means for outputting, means for transmitting, means for obtaining, means for receiving, means for obtaining, means for processing, means for performing, means for limiting and/or means for designating may include one or more processors, transceivers, or other type of circuitry.

### Example Clauses

Implementation examples are described in the following numbered clauses:
Clause 1: A method for wireless communication at a wireless node, comprising: outputting, for transmission, a first frame indicating at least one of: a first limit on an allowed number of links for association with a multi-link device (MLD) with which the wireless node is affiliated, or a second limit on a number of allowed active links; obtaining, from a client, a request to associate one or more links between the client and the AP MLD; and processing the request subject to at least the first limit.
Clause 2: The method of Clause 1, wherein the client is affiliated with a non-AP MLD.
Clause 3: The method of any one of Clauses 1-2, wherein the first frame comprises a beacon frame, a probe response frame, an association response frame, or a re-association response frame.
Clause 4: The method of any one of Clauses 1-3, wherein at least one of the first limit or the second limit is output for transmission in a common information field of a basic multi-link information element (IE).
Clause 5: The method of any one of Clauses 1-4, wherein the first frame includes at least one field indicate a presence of at least one of the first limit and the second limit.
Clause 6: The method of any one of Clauses 1-5, further comprising: obtaining an indication that the client supports the first and second limits.
Clause 7: The method of Clause 6, comprising: processing the request subject to the first limit and the second limit only after obtaining the indication.
Clause 8: The method of Clause 6, comprising: outputting the frame indicating the first limit and the second limit only after obtaining the indication.
Clause 9: The method of any one of Clauses 1-8, wherein processing the request comprises outputting, for transmission to the client, an indication that at least one of the one or more links is rejected if a number of links indicated in the request exceeds the first limit.
Clause 10: The method of Clause 9, wherein the indication comprises a status code indicating that at least one of the one or more links is rejected because the number of links indicated in the request exceeds the first limit.
Clause 11: The method of any one of Clauses 1-10, further comprising: outputting, for transmission, a second frame indicating an update to at least one of the first limit or the second limit.
Clause 12: The method of Clause 11, wherein the second frame includes at least one of: a flag indicating that there is an update to one or more operational parameters of at least one of the wireless node or the MLD with which the wireless node is affiliated, an update to a counter associated with the one or more operational parameters of at least one of the wireless node or the MLD with which the wireless node is affiliated ,or a flag indicating that information related to the update is included in the second frame.
Clause 13: The method of Clause 11, further comprising: performing a procedure to add or remove at least one link based on the update.
Clause 14: The method of any one of Clauses 1-13, further comprising:

obtaining, from the client, an indication that more than the second limit of links are in an active state; and designating most recently activated links, up to the second limit, as active after receiving the indication.
Clause 15: A method for wireless communication at a wireless node, comprising: obtaining a first frame indicating at least one of: a first limit on an allowed number of links for association with a multi-link device (MLD) affiliated with an access point (AP), or a second limit on a number of allowed active links; and outputting a request to associate one or more links between the wireless node and the MLD, subject to at least the first limit.
Clause 16: The method of Clause 15, wherein the wireless node is affiliated with a non-AP MLD.
Clause 17: The method of any one of Clauses 15-16, wherein the first frame comprises a beacon frame, a probe response frame, an association response frame, or a re-association response frame.
Clause 18: The method of any one of Clauses 15-17, wherein at least one of the first limit or the second limit is obtained in a common information field of a basic multi-link information element (IE).
Clause 19: The method of any one of Clauses 15-18, wherein the first frame includes at least one field indicate a presence of at least one of the first limit and the second limit.
Clause 20: The method of any one of Clauses 15-19, further comprising: outputting, for transmission, an indication that the wireless node supports the first and second limits.
Clause 21: The method of any one of Clauses 15-20, further comprising: obtaining an indication that at least one of the one or more links is rejected, wherein the indication comprises a status code indicating that at least one of the one or more links is rejected because the number of links indicated in the request exceeds the first limit.
Clause 22: The method of any one of Clauses 15-21, further comprising: obtaining a second frame indicating an update to at least one of the first limit or the second limit.
Clause 23: The method of Clause 22, wherein the second frame includes at least one of: a flag indicating that there is an update to one or more operational parameters of at least one of the wireless node or the MLD, an update to a counter associated with the one or more operational parameters of at least one of the wireless node or the MLD, or a flag indicating that information related to the update is included in the second frame.
Clause 24: The method of Clause 22, further comprising: performing a procedure to add or remove at least one link based on the update.
Clause 25: The method of Clause 24, wherein performing a procedure to add or remove at least one link based on the update comprises updating a power management state of at least one link, based on the update.
Clause 26: An apparatus, comprising: at least one memory comprising instructions; and at least one processor configured to execute the instructions and cause the apparatus to perform a method in accordance with any one of Clauses 1-25.
Clause 27: An apparatus, comprising means for performing a method in accordance with any one of Clauses 1-25.
Clause 28: A non-transitory computer-readable medium comprising instructions that, when executed by a processor of an apparatus, cause the apparatus to perform a method in accordance with any one of Clauses 1-25.
Clause 29: A computer program product embodied on a computer-readable storage medium comprising code for performing a method in accordance with any one of Clauses 1-25.
Clause 30: A wireless node, comprising: at least one transceiver; at least one memory comprising instructions; and one or more processors configured to execute the instructions and cause the UE to perform a method in accordance with any one of Clauses 1-14, wherein the at least one transceiver is configured to transmit the first frame.
Clause 31: A wireless node, comprising: at least one transceiver; at least one memory comprising instructions; and one or more processors configured to execute the instructions and cause the network entity to perform a method in accordance with any one of Clauses 15-25, wherein the at least one transceiver is configured to receive the first frame.

### Additional Considerations

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions. As used herein, the term wireless node may refer to, for example, an access point (AP) station (STA) or a non-AP STA. An AP STA generally refers to a STA that is (or is capable of) serving/functioning as an AP (which may be referred to simply as an AP) or capable of serving/functioning as an AP. A non-AP STA generally refers to a STA that is not serving/functioning as an AP (which may be referred to simply as an STA).

While the present disclosure may describe certain operations as being performed by one type of wireless node, the same or similar operations may also be performed by another type of wireless node. For example, operations performed by an AP STA may also (or instead) be performed by a non-AP STA. Similarly, operations performed by a non-AP STA may also (or instead) be performed by an AP STA.

Further, while the present disclosure may describe certain types of communications between different types of wireless nodes (e.g., between an AP STA and a non-AP STA), the same or similar types of communications may occur between same types of wireless nodes (e.g., between AP STAs or between non-AP STAs, in a peer-to-peer scenario). Further, communications may occur in reverse order relative to what is described.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus for wireless communication, comprising: at least one memory comprising instructions; and one or more processors configured to execute the instructions and cause the apparatus to:
output, for transmission, a first frame indicating at least one of:
a first limit on an number of links for association with a multi-link device (MLD) with which the apparatus is affiliated, and
a second limit on a number of active links;
obtain, from a client, a request to at least one of associate or activate one or more links between the client and the MLD; and
process the request subject to at least one of the first limit or the second limit.

2. The apparatus of claim 1, wherein the first frame comprises a beacon frame, a probe response frame, an association response frame, or a re-association response frame.

3. The apparatus of claim 1, wherein the first frame comprises an information element (IE) having a common information field that includes at least one of the first limit or the second limit.

4. The apparatus of claim 1, wherein the first frame includes at least one field that indicates a presence of at least one other field that includes the at least one of the first limit or the second limit.

5. The apparatus of claim 1, wherein the one or more processors are further configured to execute the instructions and cause the apparatus to:
obtain an indication that the client supports the first limit and second limit; and
process the request subject to the first limit and the second limit only after obtaining the indication.

6. The apparatus of claim 1, wherein the one or more processors are further configured to execute the instructions and cause the apparatus to:
obtain an indication that the client supports the first limit and second limit; and
output the first frame indicating the first limit and the second limit only after obtaining the indication.

7. The apparatus of claim 1, wherein the one or more processors are further configured to execute the instructions and cause the apparatus to:
obtain an indication that the client lacks support of at least one of the first limit or the second limit; and
limit a number of active links according to the second limit.

8. The apparatus of claim 1, wherein processing the request comprises outputting, for transmission to the client, an indication the request is rejected if a number of links indicated in the request exceeds at least one of the first limit or the second limit.

9. The apparatus of claim 8, wherein the indication comprises a status code indicating the request is rejected because the number of links indicated in the request exceeds the first limit.

10. The apparatus of claim 1, wherein the one or more processors are further configured to execute the instructions and cause the apparatus to output, for transmission, a second frame indicating an update to at least one of the first limit or the second limit.

11. The apparatus of claim 10, wherein the second frame includes at least one of:
a flag indicating that there is an update to parameters of the apparatus or MLD with which the apparatus is affiliated with,
a counter associated with the parameters of the apparatus or the MLD with which the apparatus is affiliated with, or
a flag indicating that information related to the update is included in the second frame itself.

12. The apparatus of claim 10, wherein the one or more processors are further configured to execute the instructions and cause the apparatus to perform a procedure to add or remove at least one link based on the update.

13. The apparatus of claim 1, wherein the one or more processors are further configured to execute the instructions and cause the apparatus to:
obtain, from the client, an indication that a quantity of links in an active state is more than the second limit; and
designate most recently activated links, up to the second limit, as active after receiving the indication.

14. The apparatus of claim 1, further comprising at least one transceiver configured to transmit the first frame, wherein the apparatus is configured as an access point (AP) device.

15. An apparatus for wireless communication, comprising: at least one memory comprising instructions; and one or more processors configured to execute the instructions and cause the apparatus to:
obtain a first frame indicating at least one of:
a first limit on an allowed number of links for association with a multi-link device (MLD) affiliated with an access point (AP), and
a second limit on a number of allowed active links; and
output a request to at least one of activate or associate one or more links between the apparatus and the MLD, subject to at least one of the first limit or the second limit.

16. The apparatus of claim 15, wherein the apparatus is affiliated with a non-AP MLD.

17. The apparatus of claim 15, wherein the first frame comprises a beacon frame, a probe response frame, an association response frame, or a re-association response frame.

18. The apparatus of claim 15, wherein the first frame comprises an information element (IE) having a common information field that includes at least one of the first limit or the second limit.

19. The apparatus of claim 15, wherein the first frame includes at least one field that indicates a presence of at least one other field that includes the at least one of the first limit or the second limit.

20. The apparatus of claim 15, wherein the one or more processors are further configured to execute the instructions and cause the apparatus to output, for transmission, an indication that the apparatus supports the first and second limits.

21. The apparatus of claim 15, wherein the one or more processors are further configured to execute the instructions and cause the apparatus to obtain an indication the request is rejected, wherein the indication comprises a status code indicating the request is rejected because a number of links indicated in the request exceeds the first limit.

22. The apparatus of claim 15, wherein the one or more processors are further configured to execute the instructions and cause the apparatus to obtain a second frame indicating an update to at least one of the first limit or the second limit.

23. The apparatus of claim 22, wherein the second frame includes at least one of:
a flag indicating that there is an update to parameters of the apparatus or MLD with which the apparatus is affiliated with,
a counter associated with the parameters of the apparatus or the MLD with which the apparatus is affiliated with, or
a flag indicating that information related to the update is included in the second frame itself.

24. The apparatus of claim 22, wherein the one or more processors are further configured to execute the instructions and cause the apparatus to perform a procedure to add or remove at least one link based on the update.

25. The apparatus of claim 24, wherein performing a procedure to add or remove at least one link based on the update comprises updating a power management state of at least one link, based on the update.

26. The apparatus of claim 15, wherein the one or more processors are further configured to execute the instructions and cause the apparatus to:
output an indication of a number of links being in an active state, wherein the number of links is greater than the second limit; and
designate most recently activated links, up to the second limit, as active after outputting the indication.

27. The apparatus of claim 15, further comprising at least one transceiver configured to receive the first frame, wherein the apparatus is configured as a client device.

28. A method for wireless communications at a wireless node, comprising:
outputting, for transmission, a first frame indicating at least one of:
a first limit on an number of links for association with a multi-link device (MLD) with which the wireless node is affiliated, and
a second limit on a number of active links;
obtaining, from a client, a request to at least one of associate or activate one or more links between the client and the MLD; and
processing the request subject to at least one of the first limit or the second limit.
